(19) United States
(12) Patent Application Publication
(10) Pub. No.: US 2025/0192829 A1
(43) Pub. Date: Jun. 12, 2025

(54) METHOD AND APPARATUS FOR CONTROLLING RECONFIGURABLE INTELLIGENT SURFACE IN COMMUNICATION SYSTEM

(71) Applicant: ELECTRONICS AND TELECOMMUNICATIONS RESEARCH INSTITUTE, Daejeon (KR)

(72) Inventors: Juho PARK, Daejeon (KR); Jihyung KIM, Daejeon (KR)

(73) Assignee: ELECTRONICS AND TELECOMMUNICATIONS RESEARCH INSTITUTE, Daejeon (KR)

(21) Appl. No.: 18/964,319

(22) Filed: Nov. 29, 2024

(30) Foreign Application Priority Data
Nov. 30, 2023 (KR) 10-2023-0171895

(51) Int. Cl. H04B 7/04; H04B 7/06; H04L 5/00; H04W 72/23; H04W 76/10

(52) U.S. Cl. CPC H04B 7/04026; H04B 7/0626; H04L 5/0048; H04W 72/23; H04W 76/10

(57) ABSTRACT

Disclosed are a method and an apparatus for controlling a reconfigurable intelligent surface in a communication system. A method of a communication node may comprise: transmitting reconfigurable intelligent surface (RIS) operation support information to a base station; receiving RIS operation configuration information from the base station; configuring a plurality of RIS elements based on the RIS operation configuration information; generating second downlink (DL) transmission(s) via the plurality of RIS elements, based on first DL transmission(s) received from the base station; and transmitting the second DL transmission(s) to a terminal.

### CROSS-REFERENCE TO RELATED APPLICATIONS

This application claims priority to Korean Patent Application No. 10-2023-0171895, filed on Nov. 30, 2023, with the Korean Intellectual Property Office (KIPO), the entire contents of which are hereby incorporated by reference.

### BACKGROUND

### 1. Technical Field

The present disclosure relates to a technique for controlling a repeater in a communication system, and more particularly, to a technique for controlling a reconfigurable intelligent surface (RIS)-based repeater.

### 2. Related Art

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a FR1 and/or FR2 band. Compared to the LTE communication network, the 5G communication network can support various communication services and scenarios.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

A reconfigurable intelligent surface (RIS) is a metasurface composed of a large number of elements, capable of controlling a phase and amplitude of an incident signal with low power consumption. Unlike conventional wireless communication, a base station may utilize an RIS to reconfigure a wireless propagation channel to suit its purpose, by enhancing a received signal strength or by suppressing unintended user signals or interference effects. The RIS may be utilized as being deployed between a base station and a user terminal.

To control the elements of the RIS, it may not be suitable for the base station to directly operate control values of all elements. The RIS may be wirelessly connected to the base station in form of a repeater. The capacity of a control channel between the base station and the RIS may be required to be minimized. The repeater utilizing the RIS may be freely deployed in various forms as needed. The arrangement of the RIS elements may have an arbitrary configuration. Methods for enhancing communication performance using the RIS are required.

### SUMMARY

The present disclosure for resolving the above-described problems is directed to providing a method and an apparatus for controlling a reconfigurable intelligent surface in a communication system.

A method of a communication node, according to exemplary embodiments of the present disclosure, may comprise: transmitting reconfigurable intelligent surface (RIS) operation support information to a base station; receiving RIS operation configuration information from the base station; configuring a plurality of RIS elements based on the RIS operation configuration information; generating second downlink (DL) transmission(s) via the plurality of RIS elements, based on first DL transmission(s) received from the base station; and transmitting the second DL transmission(s) to a terminal.

The transmitting of the RIS operation support information to the base station may comprise: transmitting information indicating whether the communication node is an RIS repeater to the base station; and transmitting the RIS operation support information to the base station, wherein the RIS operation support information includes at least one of information on RIS operable mode(s), information on parameter(s) for each of the RIS operable mode(s), or information on a number of bits for each of the parameter(s).

The information indicating whether the communication node is an RIS repeater may be included in a establishment cause of a radio resource control (RRC) connection setup request transmitted from the communication node to the base station, a resume cause of an RRC connection resume request transmitted from the communication node to the base station, or user equipment (UE) capability information which is a response to a UE capability enquiry of the base station.

The first DL transmission may be transmitted from the base station to the communication node through fixed beam(s), and the second DL transmission may be transmitted from the communication node to the terminal through beam(s) that change over time.

A number of the first DL transmission(s) may be determined based on at least one of a number of RIS operating modes configured by the base station or a number of different parameters.

The first DL transmission(s) may correspond to first synchronization signal block (SSB) transmission(s), the second DL transmission(s) may correspond to second SSB transmission(s), the first SSB transmission(s) may use first SSB transmission resource(s), the second SSB transmission(s) may use second SSB transmission resource(s), and the first SSB transmission resource(s) may be configured to have at least one of different SSB index(es), SSB transmission time resource(s), or SSB transmission frequency resource(s) from the second SSB transmission resource(s).

The first DL transmission(s) may correspond to first channel state information-reference signal (CSI-RS) transmission(s), and the second DL transmission(s) may correspond to second CSI-RS transmission(s).

The method may further comprise: transmitting second uplink (UL) transmission(s) to the base station by changing first UL transmission(s) transmitted from the terminal to the second UL transmission(s) via the plurality of RIS elements.

A method of a base station, according to exemplary embodiments of the present disclosure, may comprise: receiving reconfigurable intelligent surface (RIS) operation support information from a communication node; determining RIS operation configuration information based on the RIS operation support information; transmitting the RIS operation configuration information to the communication node; and transmitting first downlink (DL) transmission(s) to a terminal via the communication node, wherein second DL transmission(s) generated by the communication node via a plurality of RIS elements based on the first DL transmission(s) received from the base station is received by the terminal.

The receiving of the RIS operation support information from the communication node may comprise: receiving information indicating whether the communication node is an RIS repeater from the communication node; and receiving the RIS operation support information from the communication node, wherein the RIS operation support information may include at least one of information on RIS operable mode(s), information on parameter(s) for each of the RIS operable mode(s), or information on a number of bits for each of the parameter(s).

The information indicating whether the communication node is an RIS repeater may be included in a establishment cause of a radio resource control (RRC) connection setup request transmitted from the communication node to the base station, a resume cause of an RRC connection resume request transmitted from the communication node to the base station, or user equipment (UE) capability information which is a response to a UE capability enquiry of the base station.

The first DL transmission may be transmitted from the base station to the communication node through fixed beam(s), and the second DL transmission may be transmitted from the communication node to the terminal through beam(s) that change over time.

A number of the first DL transmission(s) may be determined based on at least one of a number of RIS operating modes configured by the base station or a number of different parameters.

The first DL transmission(s) may correspond to first synchronization signal block (SSB) transmission(s), the second DL transmission(s) may correspond to second SSB transmission(s), the first SSB transmission(s) may use first SSB transmission resource(s), the second SSB transmission(s) may use second SSB transmission resource(s), and the first SSB transmission resource(s) may be configured to have at least one of different SSB index(es), SSB transmission time resource(s), or SSB transmission frequency resource(s) from the second SSB transmission resource(s).

The first DL transmission(s) may correspond to first channel state information-reference signal (CSI-RS) transmission(s), and the second DL transmission(s) may correspond to second CSI-RS transmission(s).

The method may further comprise: receiving second uplink (UL) transmission(s), the second UL transmission(s) being changed via the communication node from first UL transmission(s) transmitted by the terminal.

A communication node, according to exemplary embodiments of the present disclosure, may comprise at least one processor, and the at least one processor may causes the communication node to perform: transmitting reconfigurable intelligent surface (RIS) operation support information to a base station; receiving RIS operation configuration information from the base station; configuring a plurality of RIS elements based on the RIS operation configuration information; generating second downlink (DL) transmission(s) via the plurality of RIS elements, based on first DL transmission(s) received from the base station; and transmitting the second DL transmission(s) to a terminal

The first DL transmission may be transmitted from the base station to the communication node through fixed beam(s), and the second DL transmission may be transmitted from the communication node to the terminal through beam(s) that change over time.

A number of the first DL transmission(s) may be determined based on at least one of a number of RIS operating modes configured by the base station or a number of different parameters.

The first DL transmission(s) may correspond to first synchronization signal block (SSB) transmission(s), the second DL transmission(s) may correspond to second SSB transmission(s), the first SSB transmission(s) may use first SSB transmission resource(s), the second SSB transmission(s) may use second SSB transmission resource(s), and the first SSB transmission resource(s) may be configured to have at least one of different SSB index(es), SSB transmission time resource(s), or SSB transmission frequency resource(s) from the second SSB transmission resource(s).

According to the present disclosure, regardless of an arrangement of elements of a reconfigurable intelligent surface (RIS), the RIS can control the elements based on configurations of the base station. The overhead of the control channel between the base station and the RIS can be reduced. As a result, the performance of the communication system can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a reconfigurable intelligent surface in a communication system according to exemplary embodiments of the present disclosure.

FIG. 4 is a conceptual diagram illustrating RIS operating modes for electrical control of a reconfigurable intelligent surface according to exemplary embodiments of the present disclosure.

FIG. 5 is a conceptual diagram illustrating a line-of-sight link model between a transmitter and a receiver through a reconfigurable intelligent surface repeater according to exemplary embodiments of the present disclosure.

FIG. 6 is a block diagram illustrating a structure of an RIS repeater utilizing an RIS, according to exemplary embodiments of the present disclosure.

FIG. 7 is a sequence chart illustrating an RIS element control method and procedure of an RIS according to exemplary embodiments of the present disclosure.

FIG. 8 is a conceptual diagram illustrating transmission of synchronization signal blocks via an RIS repeater according to exemplary embodiments of the present disclosure.

FIG. 9 is a sequence chart illustrating a method for transmitting synchronization signal blocks via an RIS repeater according to exemplary embodiments of the present disclosure.

FIG. 10 is a conceptual diagram illustrating CSI-RS transmission via an RIS repeater according to exemplary embodiments of the present disclosure.

FIG. 11 is a sequence chart illustrating a method for transmitting channel state information via an RIS repeater according to exemplary embodiments of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

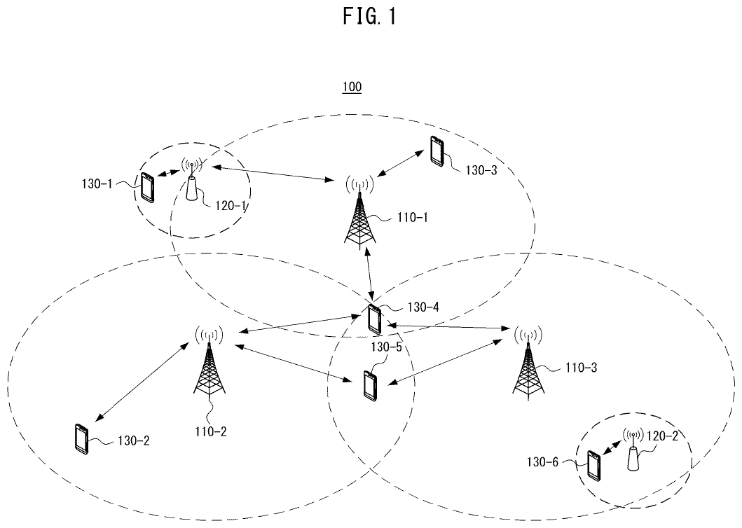

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication (e.g. enhanced version of NR), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz. The 6G communication can enable data transmission at 1 Tbps in a terahertz band and integrate terrestrial and non-terrestrial communication.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

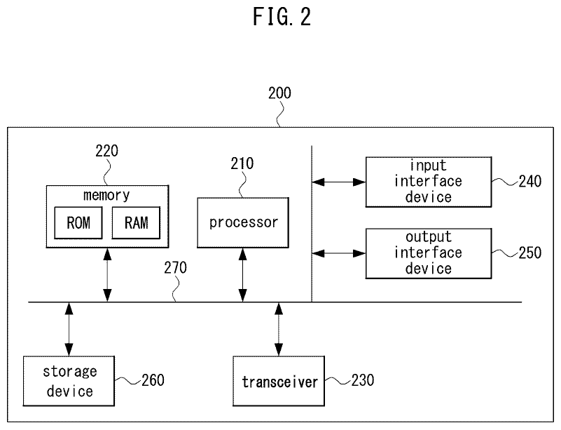

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In a communication system, multi-input multi-output (MIMO) techniques may be used for a method to enhance data transmission and meet various service requirements. When multiple antennas are used, such as in the MIMO techniques, a base station may determine control values for all antennas and provide them to an antenna control device to control the multiple antennas. For example, when multiple antennas are installed, multiple control values may be required. The base station may determine multiple control values and transmit control data including the multiple control values to the antenna control device. As the number of antennas controlled by the antenna control device increases, the control data may increase, leading to an increase in overhead for control between the base station and the antenna control device. When the base station and the antenna control device (e.g. repeater) are wirelessly connected, capacity of a control channel between the base station and the antenna control device may be limited. The base station may not be able to control the multiple antennas.

In LTE and NR, which are defined as the 3GPP standards, a pre-designed codebook may be used as a method to control multiple antennas. The base station, repeater, and terminal may share the pre-designed codebook. The base station may select an index from the pre-designed codebook and notify the selected index to minimize antenna control overhead.

In the above-described method, as the number of antennas increases, the size of the codebook also increases, leading to an increase in overhead required for control. Due to the constraint of having to select one index from the pre-designed codebook, performance may be limited. The pre-designed codebook may vary depending on the arrangement and operational configuration of antenna elements.

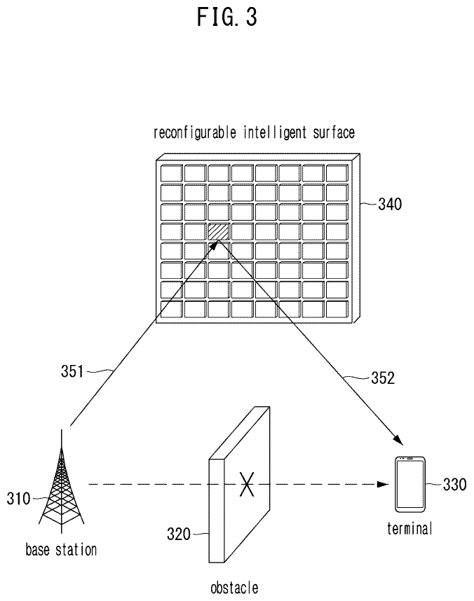

A reconfigurable intelligent surface (RIS) may be a type of reflector composed of metamaterial. The RIS may implement desired functions such as beamforming for reflected waves with low power consumption by electrically controlling RIS elements that constitute a surface. The RIS may process an incident electromagnetic wave and then reemit it. The RIS may receive an incident wave with sufficient energy on the surface to enable retransmission with a meaningful level of energy. The RIS may have a sufficiently large aperture, and as the surface area increases, the number of RIS elements constituting the RIS may become significantly larger than the number of antennas used in conventional communication systems. A communication system may form a communication path between the base station and the terminal using the RIS, as illustrated in FIG. 3.

FIG. 3 is a conceptual diagram illustrating a reconfigurable intelligent surface in a communication system according to exemplary embodiments of the present disclosure.

Referring to FIG. 3, a communication system may include a base station 310, an obstacle 320, a terminal 330, and an RIS 340. When the communication obstacle 320 is present between the base station 310 and the terminal 330, the terminal 330 may not receive a signal transmitted by the base station 310. The base station 310 may need to transmit a signal by avoiding the communication obstacle 320. The base station may use the RIS 340 to avoid the communication obstacle 320. The RIS may be positioned between the base station 310 and the terminal 330 to change the transmission path of the signal. In other words, the RIS may reflect the signal by forming a reflection path between the base station 310 and the terminal 330.

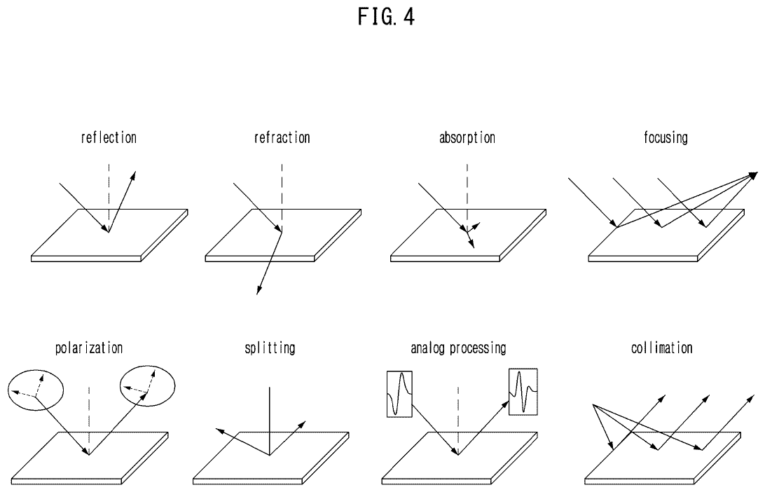

The RIS (e.g. RIS 340 in FIG. 3) may include RIS elements made of controllable metamaterial. The RIS may electrically control the RIS elements, and the RIS elements may operate in operating modes as illustrated in FIG. 4.

FIG. 4 is a conceptual diagram illustrating RIS operating modes for electrical control of a reconfigurable intelligent surface according to exemplary embodiments of the present disclosure.

Referring to FIG. 4, the RIS operating modes for electrical control may include reflection, refraction, absorption, focusing, polarization, splitting, analog processing, and collimation. In reflection and refraction, an incident wave may be reflected or refracted in a specific direction that does not necessarily match an incident direction. In absorption, an electromagnetic wave reflected and refracted from an incident wave may be nullified. In focusing, an incident wave may be concentrated at a specific location. In polarization, a polarization mode of an incident wave may be modified. For example, the incident wave may have transverse electric polarization, and the reflected wave (or reflected signal) may be modified to have transverse magnetic polarization. Splitting may refer to generating multiple reflected or refracted electromagnetic waves from an incident wave. Analog processing may refer to directly performing mathematical operations. Collimation may be considered as a complement to focusing.

Through various functions that the RIS is capable of providing, the RIS may perform a desired processing on a transmission signal and retransmit the processed transmission signal. As illustrated in FIG. 4, the RIS may perform functions such as reflection, refraction, and absorption of an incident electromagnetic wave through the electrical control of RIS elements.

In a passive RIS, only a phenomenon in which characteristics of an electromagnetic wave change when the wave enters metamaterial on a surface may be utilized. The passive RIS may fundamentally not use power amplifiers or similar components. To maximize the effect of the passive RIS, an incident electromagnetic wave may need to have sufficient energy when entering the passive RIS. This may indicate that the size of the passive RIS needs to be sufficiently large. In other words, the passive RIS needs to have a sufficiently large aperture. Increasing the size of RIS may mean that the number of RIS elements constituting the RIS needs to be significantly high.

In an exemplary embodiment, the RIS may support a 28 GHz band and may be assumed to be a square with a side length of 67 cm. The RIS may be configured with 12,132 RIS elements. The number of RIS elements that the RIS needs to control may not be in tens but in thousands to tens of thousands.

The RIS may be freely installed in various forms as needed. The arrangement of RIS elements may be configured in an arbitrary layout. For example, the RIS may be attached or installed on building exteriors, windows, or roadside objects. For aesthetic reasons, the RIS may be installed in a form that closely matches a location where it is attached. Unlike antennas in a communication system, which have a uniform one-dimensional or two-dimensional structure, the RIS may have various shapes, such as rectangular, circular, or cylindrical. When the RIS has various shapes, RIS elements included in the RIS may be arranged in various layouts. Depending on the shape of RIS, control values for the RIS elements may vary.

Hereinafter, exemplary embodiments for deriving RIS element control values will be described. When the shape of RIS is considered, in the RIS operating modes and/or the configured operating modes, RIS element control values may vary depending on an objective of the RIS.

### RIS Element Control Values: First Exemplary Embodiment

The RIS may support a millimeter wave (mmWave) band. In the mmWave band, due to high directivity and high path loss, blockage, and outdoor-to-indoor penetration loss may occur severely. To mitigate these, the RIS may be installed in form of a repeater.

As illustrated in FIG. 3, a direct link between the base station (e.g. base station 310 in FIG. 3) and the terminal (e.g. terminal 330 in FIG. 3) may be a non-line-of-sight (NLoS) link, and a communication quality thereof may be very poor. A line-of-sight (LoS) link may be ensured between the base station and the RIS and between the RIS and the terminal.

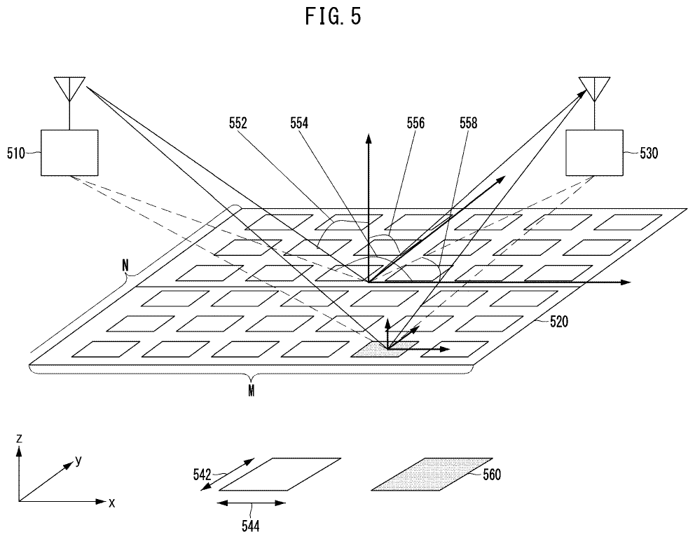

In the link (or channel) between the base station and RIS and the link (or channel) between the RIS and the terminal, LoS components may be dominant components. The link (or channel) corresponding to LoS may be determined by an angle of departure (AoD) and an angle of arrival (AoA). The AoD and AoA may be determined based on relative positions and orientations of a transmitter and a receiver. The links (or channels) between the transmitter and the receiver via the RIS repeater (or RIS) may be modeled as illustrated in FIG. 5.

FIG. 5 is a conceptual diagram illustrating a line-of-sight link model between a transmitter and a receiver through a reconfigurable intelligent surface repeater according to exemplary embodiments of the present disclosure.

Referring to FIG. 5, a communication system may include a transmitter 510, an RIS repeater 520, and a receiver 530. The RIS repeater 530 may include M RIS elements per row and N RIS elements per column, where M and N may be assumed to be even numbers. A distance (or spacing) between two RIS elements along the x-axis may be represented as dₓ, and a distance (or spacing) between two RIS elements along the y-axis may be represented as d_{y}. An elevation angle 552 and an azimuth angle 554 from the transmitter to the center of the RIS repeater may be represented as θₜ and φₜ, respectively. An elevation angle 556 and an azimuth angle 558 from the center of the RIS repeater to the receiver may be represented as θᵣ and φᵣ, respectively. An RIS element 560 located at the n-th row and m-th column of the RIS repeater may be represented as U_{n,m}. For simplicity, an RIS controller is not illustrated. However, the communication system may include an RIS controller. The communication system may be assumed to be a single-input single-output (SISO)-based communication system. In FIG. 5, the center position of U_{n,m} 560 may be represented as shown in Equation 1. The RIS element may be expressed as a unit cell.

$$( ( m - \frac{1}{2} ) {d}_{x} , ( n - \frac{1}{2} ) {d}_{y} , 0 ) , \qquad [ Equation 1 ]$$

$$m ∈ [ 1 - \frac{M}{2} , \frac{M}{2} ] , n ∈ [ 1 - \frac{N}{2} , \frac{N}{2} ]$$

As illustrated in FIG. 5, the RIS repeater 520 may operate in a mode of reflecting an incident electromagnetic wave (incident wave) in a specific direction. The RIS repeater 520 may reflect an incident wave arriving from a first direction (φₜ, θₜ) toward a desired second direction (φ_{des}, θ_{des}). To reflect the incident wave from the first direction (φₜ, θₜ) to the second direction, the RIS repeater 520 may apply control values to the respective RIS elements according to Equation 2.

$${φ}_{n , m} = mod ( \frac{2 π}{λ} ( {δ}_{1} ( m - \frac{1}{2} ) {d}_{x} + {δ}_{2} ( n - \frac{1}{2} ) {d}_{y} ) , 2 π ) \qquad [ Equation 2 ]$$

$$= mod ( - \frac{2 π}{λ} ( ( sin {θ}_{t} cos {φ}_{t} + sin {θ}_{des} cos {φ}_{des} ) ( m - \frac{1}{2} ) {d}_{x} + ( sin {θ}_{t} sin {φ}_{t} + sin {θ}_{des} sin {φ}_{des} ) ( n - \frac{1}{2} ) {d}_{y} ) , 2 π ) ,$$

$${δ}_{1} = - sin {θ}_{t} cos {φ}_{t} - sin {θ}_{des} cos {φ}_{des} , ,$$

$${δ}_{2} = sin {θ}_{t} sin {φ}_{t} + sin {θ}_{des} sin {φ}_{des}$$

In Equation 2, φ_{n,m} may represent a phase shift at the RIS element (e.g. U_{n,m} 560 in FIG. 5) corresponding to the n-row and m-th column of the RIS repeater (e.g. RIS repeater 520 of FIG. 5).

As described earlier, the number of RIS elements that the RIS repeater needs to control may range from thousands to tens of thousands. The RIS repeater may need to transmit (or deliver) thousands to tens of thousands of control values calculated using Equation 2 to the base station.

In the first exemplary embodiment of RIS element control values, a control value for each RIS element included in the RIS repeater may be obtained (or calculated) using the spacings between RIS elements (i.e. dₓ and d_{y}), incident angle information, and/or reflection angle information, as shown in Equation 2.

### RIS Element Control Values: Second Exemplary Embodiment

The environment in which the RIS is deployed may include not only a channel environment where only LOS links exist, as described in the first exemplary embodiment, but also situations where scatterers are present. A base station (e.g. base station 310 in FIG. 3) may operate by utilizing an RIS (e.g. RIS 340 in FIG. 3) to ensure the maximum SNR for a specific terminal (e.g. terminal 330 in FIG. 3). The RIS may operate to ensure the maximum SNR for the terminal by solving an optimization problem as expressed in Equation 3.

$${max}_{ϕ} {\vert {f}^{H} Φ Gw \vert}^{2} \qquad [ Equation 3 ]$$

$$s . t . 0.2 \leq A ( ∠ {Γ}_{n} ) \leq 1 , ∀ n$$

$$- π \leq ∠ {Γ}_{n} \leq π , ∀ n$$

In Equation 3, f may represent a channel between the RIS and the terminal (e.g. channel 352 in FIG. 3), and G may represent a channel between the base station and the RIS (e.g. channel 351 in FIG. 3). ϕ may represent a matrix where each element corresponds to a control value of an RIS element included in the RIS. w may represent beamforming coefficients used by the base station. A(<Γₙ) and <Γₙ may represent a magnitude and phase value of the n-th diagonal RIS element included in ϕ, respectively.

In the second exemplary embodiment of RIS element control values, the optimal solution for each RIS element included in the RIS may be obtained (or calculated) using the channel f between the RIS and the terminal, the channel G between the base station and the RIS, and the beamforming coefficients w used by the base station. The solution to the optimization problem expressed as in Equation 2 may not generally be obtained in a closed form and may be solved numerically.

The first and second exemplary embodiments of RIS element control values described above are merely examples of methods for obtaining (or calculating) RIS element control values and are not limited thereto. The RIS element control values may also be obtained (or calculated) using other method(s).

In the present disclosure, the following method (hereinafter referred to as ‘RIS element control method’) may be used for the base station and the RIS.
The base station may provide (or transmit) values of parameter(s) (hereinafter referred to as ‘RIS element control information’) required to obtain (or calculate) the RIS element control values to the RIS.
The RIS may obtain (or calculate) control coefficients (or control values) to be used for the RIS elements on its own by using the RIS element control information provided (or received) from the base station.

In the RIS element control method, the overhead for RIS control by the base station may be reduced. The RIS may obtain (or calculate) the optimal RIS element control values using the RIS element control information provided (or received) from the base station. The RIS may then control the RIS elements using the obtained (or calculated) optimal RIS element control values.

The RIS element control information may include RIS operation determination information, incident angle information, reflection angle information, and/or channel information. The RIS operation determination information may include parameter(s) that determine an RIS operation method. The parameter(s) may be expressed as fields, information elements (IEs), or information.

Hereinafter, a structure of an RIS repeater for the RIS element control method will be described.

### [Structure of RIS Repeater for RIS Element Control Method]

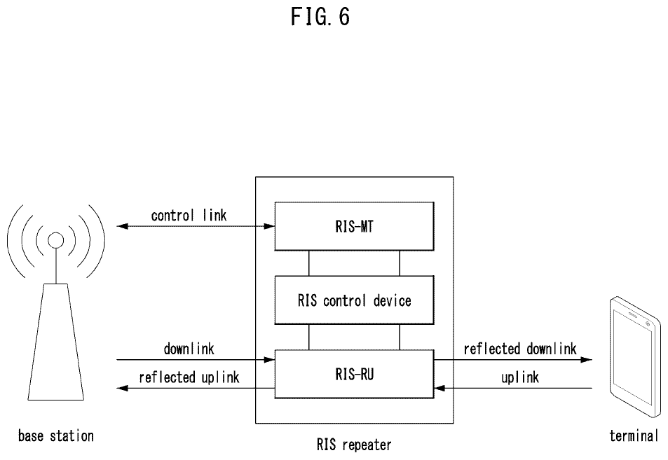

An RIS repeater utilizing an RIS may include units shown in FIG. 6.

FIG. 6 is a block diagram illustrating a structure of an RIS repeater utilizing an RIS, according to exemplary embodiments of the present disclosure.

Referring to FIG. 6, an RIS repeater may include an RIS-mobile termination (RIS-MT), an RIS control device, and an RIS-radio unit (RIS-RU). The RIS-MT may be a unit that performs part of terminal functions and may exchange RIS control information with the base station through a control link. The RIS control device may be a unit that drives hardware for controlling the RIS by obtaining (or calculating) RIS control values to control RIS elements based on the RIS control information provided (or received) from the base station via the RIS-MT. The RIS-RU may be an RIS hardware unit composed of RIS elements. The base station and the RIS-MT may be connected through the control link based on a wireless interface (e.g. NR Uu interface). Communication between the base station and the RIS-MT may be performed based on 4G, 5G, and 6G communication standards.

Referring to FIG. 6, a downlink (DL) transmitted by the base station may reach the terminal via the RIS repeater. The terminal may receive a reflected downlink (or reflected downlink signal) that is reflected via the RIS repeater. An uplink (UL) transmitted by the terminal may reach the base station via the RIS repeater. The base station may receive a reflected uplink (or reflected uplink signal) that is reflected via the RIS repeater. The base station and the terminal may transmit and receive terminal data through the reflected downlink (or reflected downlink signal) and/or the reflected uplink (or reflected uplink signal). The terminal data may include user data and/or control data.

When the RIS control information is transmitted from the base station to the RIS repeater through the control link based on a wireless interface, the base station may transmit the RIS control information to the RIS repeater using one or more of an RRC message, a MAC message (e.g. MAC control element (CE)), and a PHY message (e.g. DCI).

As described earlier, the base station and the RIS repeater may be connected through the control link based on a wireless interface (e.g. NR Uu interface). Under the control of the base station, the RIS repeater may reflect a DL signal incident on the RIS elements toward the terminal by appropriately adjusting phases of the RIS elements. The RIS repeater may also reflect an UL signal incident on the RIS elements toward the base station by appropriately adjusting phases of the RIS elements.

In FIG. 6, it has been described that the control link between the base station and the RIS-MT may be connected based on a wireless interface (e.g. NR Uu), but it is not limited thereto. The control link between the base station and the RIS-MT may also be connected based on a wired interface.

Hereinafter, an initial access method and procedure between the base station and the RIS repeater will be described.

### [RIS Element Control Method and Procedure Between Base Station and RIS Repeater]

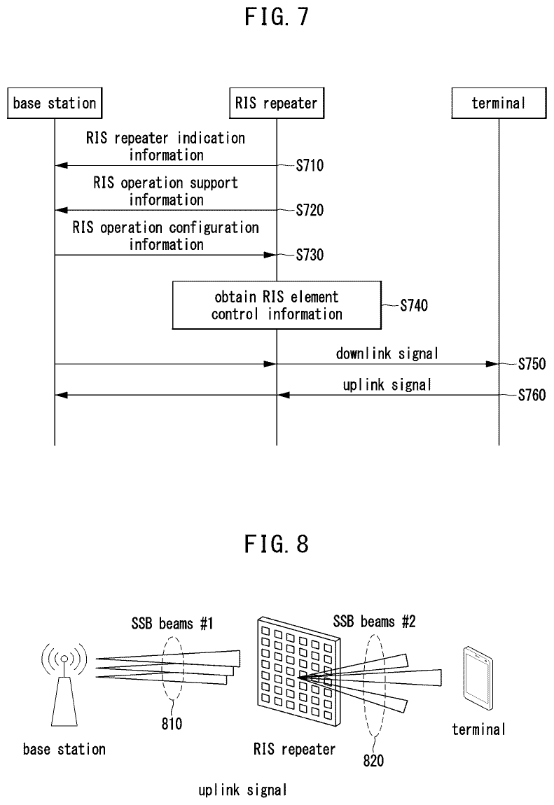

The RIS element control method and procedure between the base station and the RIS repeater (hereinafter referred to as the ‘RIS element control method and procedure’) may include the steps shown in FIG. 7.

FIG. 7 is a sequence chart illustrating an RIS element control method and procedure of an RIS according to exemplary embodiments of the present disclosure.

Referring to FIG. 7, a communication system may include a base station, an RIS repeater, and a terminal. The RIS repeater may transmit information indicating whether it operates as an RIS repeater (hereinafter referred to as ‘RIS repeater indication information’) to the base station. Then, the RIS repeater may transmit RIS operation support information to the base station. The base station may determine (or generate) RIS operation configuration information for the RIS repeater based on the RIS repeater indication information and the RIS operation support information received from the RIS repeater. The base station may transmit the determined (or generated) RIS operation configuration information to the RIS repeater. The RIS repeater may obtain RIS element control information using the RIS operation configuration information received from the base station. The RIS repeater may configure the RIS element(s) using the obtained RIS element control information. The base station may transmit a downlink signal to the terminal via the RIS. The terminal may transmit an uplink signal to the base station via the RIS.

As shown in Table 1 and Table 2, the downlink signal may include a synchronization signal (SS), a reference signal (RS), user data, and/or control data. As shown in Table 3 and Table 4, the uplink signal may include a preamble, a reference signal, user data, and/or control data.

TABLE 1

| Classification | | Description |
|---|---|---|
| Synchronization signals | | The synchronization signal (SS) is classified |
| | | into a primary synchronization signal (PSS) and |
| | | a secondary synchronization signal (SSS). |
| DL data | PDSCH | The DL data channel corresponds to a physical |
| channel | | downlink shared channel (PDSCH), and is used |
| | | for transmitting user data |
| DL control | PDCCH | The DL control channel corresponds to a |
| channel | | physical downlink control channel (PDCCH), |
| | | and is used for transmitting control information |

In Table 1, the SS may be included in a synchronization signal block (SSB) along with a physical broadcast channel (PBCH). The SSB may be arranged in 20 physical resource blocks (PRBs) in the frequency domain. In the time domain, the SSB may be arranged in four symbols (e.g. four OFDM symbols). The base station may periodically transmit the SSB to the terminal. The SS may be classified into a primary synchronization signal (PSS) and a secondary synchronization signal (SSS). The PSS may be used for radio frame synchronization, while the SSS may be used to acquire frame synchronization, cell group ID, and/or cyclic prefix (CP) configuration of a cell. The PBCH, PDCCH, and PDSCH may each include a corresponding (mapped) demodulation reference signal (DM-RS).

The SSB(s) may be repeatedly transmitted in the time domain. The SSB(s) may be transmitted in units of an SSB burst. The base station may transmit the SSB(s) according to a beam sweeping scheme. For example, the base station may transmit the SSB(s) using different beams. During a cell search procedure, the terminal may receive one or more SSBs from the base station, measure a reception quality (e.g. reference signal received power (RSRP), reference signal received quality (RSRQ), and received signal strength indicator (RSSI)) of the SSB(s), and determine an index of an SSB with the best reception quality. The terminal may determine a transmission beam of the base station associated with the identified SSB index as an optimal transmission beam.

The SSB(s) may be repeatedly transmitted through the determined transmission beam of the base station (i.e. the optimal transmission beam). The terminal may perform a measurement operation on the SSB(s) transmitted through the same transmission beam of the base station (i.e. the optimal transmission beam) by sweeping its reception beams. Based on a result of the measurement operation, the terminal may determine its optimal reception beam. According to the above-described operation, a beam pair between the base station and the terminal may be determined.

TABLE 2

| Classification | | Description |
|---|---|---|
| DL reference | CSI-RS | The channel state information-reference signal |
| signals | | (CSI-RS) is transmitted for estimation of a DL |
| | | radio channel characteristic. |
| | DM-RS | The DM-RS is used for estimation and |
| | | demodulation of a related DL physical channel. |
| | PT-RS | The phase tracking reference signal (PT-RS) is |
| | | used for removing a phase noise in a mmWave |
| | | band. |
| | PRS | The positioning reference signal (PRS) is used for |
| | | estimation of a geographical position of the |
| | | terminal. |

In Table 2, the downlink reference signals may include a channel state information reference signal (CSI-RS), a demodulation reference signal (DM-RS), a phase tracking reference signal (PT-RS), and/or a positioning reference signal (PRS). The CSI-RS may be transmitted from the base station to a single terminal. The CSI-RS may also be shared among multiple terminals. In the downlink, the DM-RS may be included in both a PDCCH and PDSCH, while the PT-RS may be included in a PDSCH. The PT-RS may be included only in a PDSCH. The CSI-RS and PRS are provided to the terminal and may not be included in a PBCH, PDCCH, or PDSCH.

TABLE 3

| Classification | | Description |
|---|---|---|
| Preamble | | The preamble is used for synchronization between |
| | | the terminal and the base station |
| UL data | PUSCH | The UL data channel corresponds to a physical |
| channel | | uplink shared channel (PUSCH), and is used for |
| | | transmitting user data |
| UL control | PUCCH | The UL control channel corresponds to a physical |
| channel | | uplink control channel (PUCCH), and is used for |
| | | transmitting control information |

In Table 3, the preamble may be transmitted through a physical random access channel (PRACH). The terminal may attempt a random access (RA) procedure to access the base station. During the RA procedure, the preamble may be transmitted to the base station through a PRACH.

In the random access procedure, the terminal may inform the base station of information on a beam pair (or information on the optimal transmission beam of the base station). A random access channel (RACH) occasion may be associated with an SSB. A RACH occasion may be a resource in which an RA preamble can be transmitted (e.g. time and/or frequency resource). The RACH occasion may be referred to as an RO.

One SSB may be associated with one or more ROs, or one RO may be associated with one or more SSBs. The base station may transmit configuration information regarding the association between ROs and SSBs to the terminal. The terminal may receive the configuration information from the base station and determine the association between ROs and SSBs based on the configuration information. The base station may configure an association between ROs and CSI-RSs for the terminal. The configuration information for the association may be transmitted through a system information block (SIB) and/or an RRC message.

TABLE 4

| Classification | | Description |
|---|---|---|
| UL reference | DM-RS | The DM-RS is used for channel estimation and |
| signals | | demodulation of a related physical channel. |
| | | The DM-RS may be included in each of a |
| | | PUCCH and a PUSCH |
| | PT-RS | The PT-RS is used for removing a phase noise |
| | | in a mmWave band. |
| | | The UL PT-RS may be included in a PUSCH. |
| | SRS | The sounding reference signal (SRS) is used |
| | | for estimation of a UL radio channel |
| | | characteristic. |

In Table 4, the UL DM-RS may be used as an RS for channel estimation and channel decoding for both a PUCCH and PUSCH. The UL PT-RS may be included in a PUSCH as an RS for phase noise removal in a PUSCH channel in a mmWave band. The UL SRS may correspond to a DL CSI-RS and may be used to estimate the uplink channel.

After the initial access procedure is completed, a beam management procedure may be performed using SSB, CSI-RS, and/or SRS. The beam management procedure may be performed for downlink, uplink, and/or sidelink communication. The beam management procedure may include a beam selection procedure, a beam change procedure, and/or a beam refinement procedure. In the beam refinement procedure, a narrower beam may be determined, and by using the narrower beam, additional beam gain may be obtained while interference may be reduced.

The downlink beam management procedure may be divided into a selection procedure for a transmission beam of the base station and a selection procedure for a reception beam of the terminal.

The base station may transmit signals based on a beam sweeping scheme. The signals may include synchronization signals (e.g. SSB), reference signals (e.g. CSI-RS, DM-RS, SRS, PT-RS), and/or channels. When the base station transmits a CSI-RS, a transmission beam of the base station may be distinguished by a CSI-RS resource indicator (CRI) assigned to the corresponding transmission beam. The terminal may receive the signal from the base station and perform a measurement operation on the signal. The terminal may perform the measurement operation using a fixed reception beam. For example, the terminal may measure an RSRP (or RSRQ, RSSI) of the signal. The terminal may report the RSRP values for up to four transmission beams to the base station. For example, the terminal may transmit the largest RSRP and differences between the largest RSRP and the other three RSRP values to the base station. The base station may receive the RSRP values of the transmission beam(s) from the terminal and select the optimal transmission beam based on the RSRP value(s). For example, a transmission beam associated with a CRI #3 may be determined as the optimal transmission beam.

The terminal's reception beam selection procedure may be performed after completing the aforementioned transmission beam selection procedure. The base station may repeatedly transmit a signal (e.g. CSI-RS) using a single transmission beam in the time domain. The single transmission beam may be the optimal transmission beam selected in the aforementioned transmission beam selection procedure. The terminal may perform a measurement operation on the received signal from the base station by sweeping its reception beams. The terminal may select a reception beam with the highest RSRP (or RSRQ, RSSI) among the reception beams as the optimal reception beam. In the aforementioned downlink beam management procedure, a downlink beam pair between the base station and the terminal may be selected. The downlink beam pair may include the transmission beam of the base station and the reception beam of the terminal. If beam correspondence is assumed, the downlink beam pair may be regarded as an uplink beam pair. In other words, the transmission beam of the base station in the downlink beam pair may be regarded as a reception beam of the base station in uplink communication, and the reception beam of the terminal in the downlink beam pair may be regarded as a transmission beam of the terminal in uplink communication. In this case, a separate uplink beam management procedure may not be performed.

If beam correspondence is not assumed, an uplink beam management procedure may be performed to determine an uplink beam pair. In the uplink beam management procedure, the terminal may transmit one or more SRSs based on a beam sweeping scheme, and the base station may perform a measurement operation on the received SRS(s) from the terminal. The base station may report a result of the measurement operation (e.g. RSRP values of the SRSs) to the terminal, and the terminal may determine the optimal transmission beam based on the RSRP values received from the base station. The terminal may transmit one or more SRSs using a single transmission beam (e.g. the optimal transmission beam), and the base station may perform a measurement operation on the received SRSs by performing beam sweeping. The base station may select a reception beam with the highest RSRP among the reception beams as the optimal reception beam.

Referring again to FIG. 7, the base station may correspond to the base station 310 shown in FIG. 3, the terminal may correspond to the terminal 330 shown in FIG. 3, and the RIS repeater may correspond to the RIS 340 shown in FIG. 3. As shown in FIG. 6, the RIS repeater may include an RIS-MT that performs terminal functions. The base station, terminal, and RIS repeater may be configured similarly to the communication nodes shown in FIG. 2. The RIS element control method and procedure between the base station and the RIS repeater may include steps S710 to S760 as follows.

In step S710, the RIS-MT may transmit RIS repeater indication information to the base station, and the base station may receive the RIS repeater indication information from the RIS-MT. The base station may confirm the connection of the RIS-MT based on the RIS repeater indication information received from the RIS-MT.

In an exemplary embodiment, it may be assumed that the RRC connection between the base station and the RIS-MT has not been established. The RRC connection between the base station and the RIS-MT may be in an RRC idle state (e.g. ‘RRC_IDLE’ state). The RIS-MT may initiate an initial access (IA) procedure with the base station.

When the IA procedure is performed, the RIS-MT may acquire a synchronization signal and system information of the base station and perform an RA procedure with the base station. In the RA procedure, the RIS-MT may transmit an RRC setup request including the RIS repeater indication information to the base station. The base station may receive the RRC setup request including the RIS repeater indication information from the RIS-MT. The RRC setup request including the RIS repeater indication information may be represented as shown in Table 5.

TABLE 5

| | |
|---|---|
| RRCSetupRequest ::= | SEQUENCE { |
| rrcSetupRequest | RRCSetupRequest-IEs |

}

| | |
|---|---|
| RRCSetupRequest-IEs ::= | SEQUENCE { |

| | |
|---|---|
| ue-Identity | InitialUE-Identity, |

| | |
|---|---|
| establishmentCause | EstablishmentCause, |

| | |
|---|---|
| spare | BIT STRING (SIZE (1)) |

}

| | |
|---|---|
| Initialize-Identity ::= | CHOICE { |

| | |
|---|---|
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED {emergency, highPriorityAccess, mt-Access, mo- |

Signalling, mo-Data, mo-VoiceCall, mo-SMS, mps-PriorityAccess, mcs-PriorityAccess, ris-
Signaling, spare5, spare4, spare3, spare2, spare 1}

In Table 5, the RRC setup request may include UE identifier information (e.g. ‘ue-Identity’) and establishment cause information (e.g. ‘EstablishmentCause’). The establishment cause information may include the RIS repeater indication information (e.g. ‘ris-Signaling’). The information may be expressed as a ‘parameter’ or a ‘field’.

In another exemplary embodiment, the RRC connection between the base station and the RIS-MT may be assumed to be in an inactive state. If a predefined RRC connection resumption condition is met, the RIS-MT may transmit an RRC connection resumption request (e.g. RRCResumeRequest, RRCResumeRequest1) including RIS repeater indication information to the base station. The base station may receive the RRC connection resumption request (e.g. RRCResumeRequest, RRCResumeRequest1) including the RIS repeater indication information from the RIS-MT. The RRC connection resumption request including the RIS repeater indication information may include an RRC resumption cause IE (e.g. RRCResumeCause) as shown in Table 6.

TABLE 6
ResumeCause ::= ENUMERATED {emergency, highPriorityAccess,
mt-Access, mo-Signalling, mo-Data, mo-VoiceCall, mo-SMS,
mps-PriorityAccess, mcs-PriorityAccess, ris-Signaling, spare5, spare4,
spare3, spare2, spare1}

Referring to Table 6, the RRC resumption cause IE (e.g. RRCResumeCause) may include the RIS repeater indication information (e.g. ris-Signaling) as a reason for performing the RRC resumption procedure.

In another exemplary embodiment, the RIS-MT may perform an initial access (IA) procedure with the base station to establish a connection with the base station. The RRC connection between the base station and the RIS-MT may be assumed to be in a connected state (e.g. ‘RRC_CONNECTED’ state). The base station may transmit a UE capability enquiry (e.g. ‘UECapabilityEnquiry’) to the RIS-MT. The RIS-MT may receive the UE capability enquiry from the base station. In response to the UE capability enquiry received from the base station, the RIS-MT may transmit UE capability information (e.g. ‘UECapabilityInformation’) including the RIS repeater indication information to the base station.

The base station may receive the UE capability information, which includes the RIS repeater indication information, from the terminal. The UE capability information that includes the RIS repeater indication information may be represented as shown in Table 7. The base station may refer only to the UE capability information after access stratum (AC) security activation. The base station may not retransmit or report the UE capability information before AS security activation to the core network (CN).

TABLE 7

| | |
|---|---|
| UECapabilityInformation ::= | SEQUENCE { |

| | |
|---|---|
| rrc-TransactionIdentifier | RRC-TransactionIdentifier, |
| criticalExtensions | CHOICE { |

| | |
|---|---|
| ueCapabilityInformation | UECapabilityInformation-IEs, |

| | |
|---|---|
| criticalExtensionsFuture | SEQUENCE { } |

| } | |
|---|---|
| } | |
| UECapabilityInformation-IEs ::= | SEQUENCE { |
| ue-CapabilityRAT-ContainerList | UE-CapabilityRAT-ContainerList, |

| | |
|---|---|
| lateNonCriticalExtension | OCTET STRING, |
| nonCriticalExtension | SEQUENCE{ } |

}

In Table 7, the UECapabilityInformation message may include terminal type information indicating that the terminal type is RIS-MT.

If the RIS-MT successfully transmits the RIS repeater indication information to the base station in step S710, the RIS-MT may perform step S720 to inform the base station of operating modes supported by the RIS repeater. It may be assumed that all RIS operating modes that the RIS repeater supports are pre-shared between the base station and the RIS-MT.

In step S720, the RIS-MT may transmit RIS operation support information, which includes the RIS operable mode(s) in which the RIS repeater is able to operate, parameters for each RIS operable mode, and/or the number of bits for each parameter, to the base station. The base station may receive the RIS operation support information, which includes the RIS operable mode(s), parameters for each RIS operable mode, and/or the number of bits for each parameter, from the RIS-MT. The RIS operable mode(s) may include the RIS operating mode(s) in which the RIS repeater can operate among all RIS operating modes pre-shared between the base station and the RIS repeater.

As described above, the RIS operation support information may include RIS operable mode(s), required parameter(s) for each RIS operable mode, and/or the number of bits for each parameter. First, the RIS operable mode(s) will be described.

### Exemplary Embodiments of RIS Operable Mode(s)

In an exemplary embodiment, reflection, absorption, beamforming, transmission, and polarization change may be assumed as RIS operating modes pre-shared between the base station and the RIS repeater. Among the RIS operating modes pre-shared between the base station and the RIS repeater, reflection, beamforming, and transmission may be RIS operable modes for the RIS control device (e.g. the RIS control device in FIG. 6). The RIS-MT (e.g. the RIS-MT in FIG. 6) may provide the RIS control device with RIS operating modes pre-shared between the base station and the RIS repeater. The RIS control device may provide the RIS-MT with information on the operable modes for the RIS repeater. The information on the operable modes for the RIS repeater may be represented as shown in Table 8.

TABLE 8

| | Operating modes | | | | |
|---|---|---|---|---|---|
| | | Absorp- | | Trans- | Polarization |
| | Reflection | tion | Beamforming | mission | change |
| Bit value | 1 | 0 | 1 | 1 | 0 |

In Table 8, if a bit value for an operating mode is set to ‘1’, it may indicate that the corresponding operating mode is operable in the RIS repeater (e.g. the RIS control device in FIG. 6). If a bit value for an operating mode is set to ‘0’, it may indicate that the corresponding operating mode is not operable in the RIS repeater (e.g. the RIS control device in FIG. 6). As described earlier, reflection, absorption, beamforming, transmission, and polarization change may be RIS operating modes pre-shared between the base station and the RIS repeater. The operating modes that are operable in the RIS repeater (e.g. the RIS control device in FIG. 6) may be represented as ‘RIS operable modes’, while the operating modes that are not operable in the RIS repeater (e.g. the RIS control device in FIG. 6) may be represented as ‘RIS non-operable modes’.

As described earlier, reflection, absorption, beamforming, transmission, and polarization change may be assumed as RIS operating modes pre-shared between the base station and the RIS repeater. In other words, reflection, absorption, beamforming, transmission, and polarization change may be all RIS operating modes pre-agreed upon between the base station and the RIS repeater. Each RIS repeater connected to the base station may provide some or all of the listed functions (i.e. reflection, absorption, beamforming, transmission, and polarization change) depending on its design. The RIS-MT included in the RIS repeater may perform an operation during the initial access process to notify the base station that it is an RIS repeater and inform the base station of the functions it is able to provide among the pre-agreed RIS functions.

In another exemplary embodiment, reflection, absorption, beamforming, transmission, and polarization change may be assumed as RIS operating modes pre-shared between the base station and the RIS repeater. The RIS-MT may not provide the RIS control device with the RIS operating modes pre-shared between the base station and the RIS repeater. The RIS control device may include information on predefined operable modes in the RIS repeater (e.g., reflection and beamforming). The RIS control device may provide the RIS-MT with information on the predefined operable modes of the RIS repeater. These operable modes may be the minimum requirement for the RIS repeater.

Hereinafter, the required parameters for each RIS operable mode in the RIS operation support information will be described. Through the RIS operation support information, the RIS-MT may inform (or provide) the base station of which parameters are required when the RIS control device operates in a specific RIS operating mode.

### Exemplary Embodiments of Required Parameter(s) for Each RIS Operable Mode

In an exemplary embodiment, among the RIS operating modes pre-shared between the base station and the RIS repeater, reflection, beamforming, and transmission may be RIS operable modes in the RIS control device. When the RIS operable mode is reflection, Parameter 1 and Parameter 2 may be required parameter(s). When the RIS operable mode is beamforming, Parameter 2, Parameter 3, and Parameter 4 may be required parameter(s). When the RIS operable mode is transmission, Parameter 1 may be required parameter(s). The required parameter(s) for each RIS operable mode may be represented as shown in Table 9.

TABLE 9

| Operating | | | | |
|---|---|---|---|---|
| mode | Parameter 1 | Parameter 2 | Parameter 3 | Parameter 4 |
| Reflection | ◯ | ◯ | X | X |
| Beamforming | X | ◯ | X | ◯ |
| Transmission | ◯ | X | X | X |

In Table 9, ‘O’ may indicate that the corresponding parameter is a required parameter in the RIS operable mode, while ‘X’ may indicate that the corresponding parameter is not required in the RIS operable mode. This is for convenience of description and the present disclosure is not limited thereto. In another exemplary embodiment, among the RIS operating modes pre-shared between the base station and the RIS repeater, reflection, beamforming, and transmission may be RIS operable modes in the RIS control device. The RIS-MT may not provide required parameter(s) for each RIS operable mode. The base station may predefine and use parameters to be provided to the RIS repeater for each operating mode.

The RIS control device may require different parameter(s) depending on a method of obtaining RIS element control values, even for the same operating mode. The required parameter(s) for each RIS operable mode described above may be determined according to predefined regulations between the base station and the RIS. Various parameter(s) may be used to obtain incident angle information, reflection angle information, channel information, and RIS element control information.

The exemplary embodiments of the required parameter(s) for each RIS operable mode described above are provided for convenience of description and are not limited thereto.

Hereinafter, the number of bits for each parameter in the RIS operation support information will be described. The number of bits for each parameter may vary depending on a control algorithm used by the RIS control device, implementation of the algorithm, and/or hardware configuration of the RIS elements.

### Exemplary Embodiments of Information on the Number of Bits for Required Parameters

As described above, the RIS-MT may inform (or provide) the base station, through the RIS operation support information, of which parameter(s) are required when the RIS control device operates in a certain RIS operating mode. Through the RIS operation support information, the RIS-MT may also inform (or provide) the base station with information on the desired number of bits for each parameter. The base station may use the information on the desired number of bits for each of the required parameters, which is provided (or received) from the RIS-MT, or use the number of bits predefined by the base station.

In an exemplary embodiment, among the RIS operating modes pre-shared between the base station and the RIS repeater, reflection, beamforming, and transmission may be RIS operable modes in the RIS control device. When the RIS operable mode is reflection, Parameters 1 through 4 may be required parameters. For Parameters 1 through 4, the number of bits for each required parameter may be represented as shown in Table 10.

TABLE 10

| | Parameter 1 | Parameter 2 | Parameter 3 | Parameter 4 |
|---|---|---|---|---|
| Number of bits | 6 | 6 | 8 | 12 |

Referring to Table 10, the information on the number of bits for each required parameter may include a value indicating a bit count for each required parameter. Parameters 1 through 4 may refer to the required Parameters 1 through 4.

The exemplary embodiments of the information on the number of bits for each required parameter described above are provided for convenience of description and are not limited thereto.

As described above, the RIS-MT may perform step S720 to transmit (or provide) the RIS operation support information to the base station. The RIS operation support information may include RIS operable mode(s), parameters required for each RIS operable mode, and/or the bit count for each parameter. When necessary, the RIS-MT may provide (or transmit) additional required information to the base station. The RIS-MT may transmit RIS operation support information that further includes the additional required information to the base station. For example, when the base station instructs the RIS repeater to operate in a specific RIS operating mode, the additional required information may include a delay value necessary for operating in the specific RIS operating mode. In another example, the additional required information may include at least one piece of information that is determined to be necessary for the RIS repeater to provide (or transmit) to the base station in order to operate.

Based on the RIS operation support information received from the RIS repeater in step S720, the base station may determine in which RIS operating mode the RIS repeater is to operate and determine values of the required parameter(s) for operating in the corresponding RIS operating mode. In other words, based on the RIS operation support information received from the RIS repeater, the base station may determine (or generate) RIS operation configuration information for controlling the RIS repeater. The RIS operation configuration information may be information for deriving control values at the RIS element level, rather than the control values themselves.

In step S730, the base station may transmit the RIS operation configuration information to the RIS repeater, and the RIS repeater may receive the RIS operation configuration information from the base station. The RIS operation configuration information may include RIS operating mode information and/or required parameter(s).

Based on the RIS operation support information received from the RIS repeater, in step S730, the base station may determine (or generate) the RIS operation configuration information that includes the RIS operating mode and/or the required parameter(s) for controlling the RIS repeater. The RIS operation configuration information may further include parameter(s) that are not included in the RIS operation support information. The RIS operation support information may be received from the RIS repeater in step S720.

The RIS repeater may perform step S740 to control the RIS elements according to the RIS operation configuration information received from the base station in step S730.

In step S740, the RIS-MT may transmit (or provide) the RIS operation configuration information received from the base station in step S730 to the RIS control device. The RIS control device may obtain (or generate) control information for the RIS elements (hereinafter referred to as ‘RIS element control information’) using the RIS operation configuration information transmitted (or provided) from the RIS-MT. The RIS control device may adjust the hardware according to the obtained (or generated) RIS element control information to operate the RIS-RU.

In step S750, the base station may transmit a DL signal to the terminal via the RIS-RU. The terminal may receive the DL signal (e.g. downlink signal reflected in FIG. 6) from the base station via the RIS-RU. As shown in Table 1 and Table 2, the DL signal may include a synchronization signal, a DL data channel, a DL control channel, and/or a DL RS.

In step S760, the terminal may transmit a UL signal to the base station via the RIS-RU. The base station may receive the UL signal (e.g. uplink signal reflected in FIG. 6) from the terminal via the RIS-RU. As shown in Table 3 and Table 4, the UL signal may include a preamble, a UL data channel, a UL control channel, and/or a UL RS.

Although steps S710 through S760 are described separately, this is not intended to limit the order in which the steps are performed. When necessary, the respective steps may be performed simultaneously, in a different order, or combined.

If the signal from the base station does not reach the terminal directly, a coverage hole of the base station may occur, preventing the terminal from receiving communication services from the base station. As shown in FIG. 3, if the terminal is located in a coverage hole of the base station, the base station and the terminal may establish a communication link via the RIS repeater. Without the RIS repeater, the terminal located in the coverage hole of the base station may not receive SSB signals. To prevent coverage holes of the base station, the base station may provide SSB signals to terminals located in coverage holes via the RIS repeater. The terminal may receive the SSB signals through the RIS repeater and successfully perform an initial access procedure.

A method of transmitting SSBs via the RIS repeater by the base station may differ from the conventional SSB transmission method. The base station may apply the conventional SSB transmission method to terminals that do not need to access via the RIS repeater. However, for terminals accessing via the RIS repeater, a new initial access procedure (or random access procedure) may be required. The base station may determine which RIS operating modes the RIS repeater can operate in. The base station may also determine which parameter(s) to transmit for each operating mode.

Hereinafter, a method for transmitting SSB(s) from the base station to the terminal via the RIS repeater will be described.

### [SSB Transmission Method Via RIS Repeater]

The RIS repeater may access the base station through an initial access procedure (or a random access procedure). The base station may determine (or identify) beam(s) to be used to reach the RIS repeater. The base station may add RIS-specific SSB resources to the existing SSB resources. In the initial access procedure (or random access procedure) via the RIS, the added SSB resources may be used.

FIG. 8 is a conceptual diagram illustrating transmission of synchronization signal blocks via an RIS repeater according to exemplary embodiments of the present disclosure.

Referring to FIG. 8, a communication system may include a base station, an RIS repeater, and a terminal. The base station may add SSB resources for the RIS repeater to the existing SSB resources. Using the added SSB resources, the base station may transmit SSB(s) to the terminal via the RIS repeater. In the SSB transmission(s), SSB beams #1 810 and SSB beams #2 820 may be applied. The SSB transmission(s) between the base station and the RIS repeater may use the SSB beams #1 810, while the SSB transmission(s) between the RIS repeater and the terminal may use the SSB beams #s 820. The SSB beams #1 810 may be fixed and narrow beams, while the SSB beams #2 820 may be wide beams. The added SSB resources may be configured differently from the existing SSB resources in terms of SSB indexes, SSB transmission time resources, and SSB transmission frequency resources. The SSB beams #1 810 may be referred to as first SSB beams, while the SSB beams #2 820 may be referred to as second SSB beams. The positions of the base station and the RIS repeater may be assumed to be fixed.

The difference between the added SSB resources for the RIS repeater and the existing SSB resources may be that when the base station transmits the SSBs, its beam does not change and is fixedly transmitted toward the RIS. The RIS repeater may access the base station through an initial access procedure. The base station may determine (or identify) beam(s) to be used to reach the RIS repeater. The base station may add SSB resources for the RIS repeater to the existing SSB resources. The SSB transmission(s) transmitted by the base station may be provided to the terminal via the RIS repeater using the added SSB resources. When the base station transmits SSB(s) to the terminal using the added SSB resources, the SSB beams #1 810 and SSB beams #2 820 may be applied.

The base station may determine SSB indexes, SSB transmission time resources, and/or SSB transmission frequency resources for the SSB resources added for the RIS repeater. The number of SSB transmissions from the base station to the RIS repeater may be determined based on the number of RIS operating modes configured by the base station and/or the number of different parameters. In other words, the number of SSB transmissions from the base station to the RIS repeater may be determined (or set) as a product of the number of operating modes configured for the RIS repeater by the base station and the number of different parameters. For example, if the number of different parameters varies for each operating mode, the number of different parameters may be the maximum value among the different numbers of parameters for the respective operating modes.

If the positions of the base station and the RIS repeater are fixed, the beam(s) used by the base station to transmit the SSBs to the RIS repeater may be fixed beam(s). The base station may transmit the added SSB transmissions for the RIS repeater multiple times over time using the fixed beam(s).

The base station may transmit the SSB using the same beam, but its SSB index may change depending on a transmission time. The terminal may perform the initial access procedure (or random access procedure) according to the received SSB index.

RACH resources (e.g. RACH preamble sequences, RACH time/frequency resources, etc.) used by the terminal accessing via the RIS repeater may be configured differently from those used by the terminal directly accessing the base station. The base station may confirm that the terminal accesses via the RIS repeater in the initial access procedure (or random access procedure).

For the terminal to access the base station via the RIS repeater, not only SSB(s) but also system information (SI) may be provided (or transmitted) to the terminal. The base station may inform the RIS repeater in advance of a timing at which the SI associated with the SSB added for the RIS repeater is to be provided. The RIS repeater may use RIS control values previously used for transmitting the existing SSB to ensure that the SI reaches the terminal at the timing the SI is provided.

The terminal that has acquired the system information may transmit an RA preamble to the base station to notify that the terminal has been added. The base station may inform the RIS repeater in advance of a RACH occasion associated with the SSB added for the RIS repeater. The RIS repeater may use RIS control values used for the existing SSB transmission at a timing corresponding to the RACH occasion to ensure that the RA preamble reaches the base station.

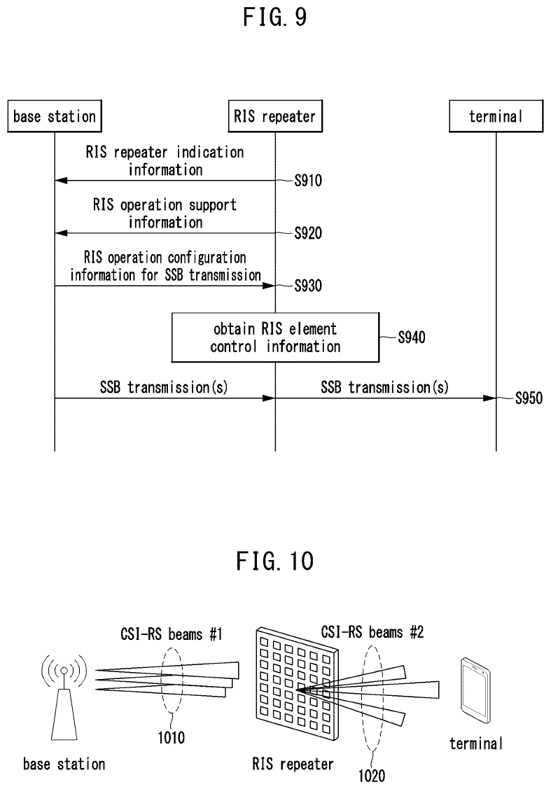

FIG. 9 is a sequence chart illustrating a method for transmitting synchronization signal blocks via an RIS repeater according to exemplary embodiments of the present disclosure.

Referring to FIG. 9, the base station may determine (or generate) RIS operation configuration information for transmitting SSB(s) to the terminal via the RIS repeater based on RIS operation support information received from the RIS repeater. Before the SSB(s) are transmitted from the base station to the terminal via the RIS repeater, the base station may transmit the determined (or generated) RIS operation configuration information to the RIS repeater. The RIS repeater may obtain RIS element control information in advance using the RIS operation configuration information received from the base station and may configure the RIS element(s). The base station may provide (or transmit) the SSB(s) to the terminal via the RIS repeater. In FIG. 9, when describing the SSB transmission method via the RIS repeater, similar or redundant descriptions regarding the RIS element control method and procedure described above may be omitted.

In step S910 and step S920, the base station may receive RIS repeater indication information and RIS operation support information from the terminal. Step S910 may correspond to step S710, and step S920 may correspond to step S720.

In step S930, the base station may determine (or generate) RIS operation configuration information for transmitting SSB(s) to the terminal via the RIS repeater based on the RIS operation support information received from the RIS repeater. Before the SSB(s) are transmitted from the base station to the terminal via the RIS repeater, the base station may transmit the determined (or generated) RIS operation configuration information to the RIS repeater. The RIS repeater may receive the RIS operation configuration information for transmitting the SSB(s) to the terminal via the RIS repeater from the base station.

In step S940, the RIS repeater may obtain RIS element control information using the RIS operation configuration information received from the base station. The RIS repeater may configure the RIS element(s) according to the obtained RIS element control information.

In step S930, the base station may inform the RIS repeater in advance of which operating mode the RIS repeater is to operate in at a time of SSB transmission(s) and whether to use values of required parameter(s) when operating in the corresponding RIS operating mode. In step S940, the RIS repeater may obtain (or generate) control values for the RIS element(s) in advance based on the information. The RIS repeater may use the corresponding control values at the time when the SSB(s) are transmitted.

In step S950, the base station may provide (or transmit) SSB transmission(s) to the terminal via the RIS repeater. The SSB transmission(s) between the base station and the RIS repeater may be transmitted using first SSB beams (e.g. SSB beams #1 810 in FIG. 8). The SSB transmission(s) between the RIS repeater and the terminal may be transmitted using second SSB beams (e.g. SSB beams #2 820 in FIG. 8). The terminal may receive the SSB transmission(s) through the second SSB beams.

The terminal may perform the RA procedure with the base station based on the SSB transmission(s) received through the second SSB beams. The terminal may access the base station according to the RA procedure. When the base station and the terminal are in an RRC connected state, the terminal may receive downlink data from the base station. The terminal may transmit uplink data to the base station.

According to configuration information, the terminal may measure a channel state between the RIS repeater and the terminal using the SSB transmission(s) received through the second SSB beams to acquire channel state information. The terminal may provide (or report) the acquired channel state information to the base station via the RIS repeater. The base station may determine whether to change the RIS operation configuration information based on the channel state information provided (or reported) by the terminal. If the base station determines that the RIS operation configuration information needs to be changed, the base station may transmit the RIS operation configuration information to be changed to the RIS repeater. The RIS repeater may reconfigure the RIS element(s) based on the RIS operation configuration information to be changed. Thereafter, the base station may provide (or transmit) SSB transmission(s) to the terminal through the reconfigured RIS element(s).

As described above, the first SSB beams may be fixed and narrow beams used between the base station and the RIS repeater. The second SSB beams may be wide beams used between the RIS repeater and the terminal. The RIS repeater may use third SSB beams instead of the first and second SSB beams in the RA procedure with the base station. The third SSB beams may be SSB beams using existing SSB resources. The RA procedure between the base station and the RIS repeater may be performed by the RIS-MT included in the RIS repeater, as illustrated in FIG. 3.

In the above-described SSB transmission method via the RIS repeater, although steps S910 through S950 are described separately, this is not intended to limit the order in which the steps are performed. When necessary, the respective steps may be performed simultaneously, in a different order, or combined.

Next, a method for transmitting CSI-RS(s) from the base station to the terminal via the RIS repeater (hereinafter referred to as ‘CSI-RS transmission method via the RIS repeater’) will be described. When describing the CSI-RS transmission method via the RIS repeater, similar or redundant descriptions regarding the RIS element control method and procedure and the SSB transmission method via the RIS repeater described above may be omitted.

### [CSI-RS Transmission Method Via the RIS Repeater]

The RIS repeater may not be able to generate signals independently. The RIS repeater may allow a CSI-RS transmitted by the base station to reach the terminal through reflection, transmission, or the like. The terminal may perform a measurement operation to acquire channel state information for a channel between the RIS repeater and the terminal (e.g. RIS-terminal channel 352 in FIG. 3). The terminal may perform the measurement operation to acquire channel state information. The terminal may provide (or report) the acquired channel state information to the base station. The base station may perform CSI-RS transmission(s) to the terminal via the RIS repeater as follows. As described above, the positions of the base station and the RIS repeater may be assumed to be fixed.

FIG. 10 is a conceptual diagram illustrating CSI-RS transmission via an RIS repeater according to exemplary embodiments of the present disclosure.

Referring to FIG. 10, in CSI-RS transmission(s) transmitted from the base station to the terminal, CSI-RS beams #1 1010 and CSI-RS beams #2 1020 may be applied. In the CSI-RS transmission(s) between the base station and the RIS repeater, the CSI-RS beams #1 1010 may be applied. In the CSI-RS transmission(s) between the RIS repeater and the terminal, the CSI-RS beams #2 1020 may be applied. The CSI-RS beams #1 1010 may be fixed beams. The CSI-RS beams #1 1010 may be narrow beams. The CSI-RS beams #2 1020 may not be fixed beams. The CSI-RS beams #2 1020 may be narrow beams.

Referring to FIG. 10, under the control of the base station, the CSI-RS transmission(s) may reach the terminal via the RIS repeater. The terminal may receive the CSI-RS transmission(s) from the base station via the RIS repeater. The CSI-RS beams #1 1010 may be referred to as first CSI-RS beams, and the CSI-RS beams #2 1020 may be referred to as second CSI-RS beams.

If the positions of the base station and the RIS repeater are fixed, beam(s) used by the base station to transmit CSI-RS(s) to the RIS repeater may be fixed beam(s). The base station may transmit CSI-RS(s) added for the RIS repeater multiple times to the RIS repeater over time using the fixed beam(s). The number of CSI-RS symbols transmitted multiple times from the base station to the RIS repeater may be determined based on the number of RIS operating modes configured by the base station and/or the number of different parameters. In other words, the number of CSI-RS symbols transmitted multiple times from the base station to the RIS repeater may be determined (or set) as a product of the number of operating modes configured for the RIS repeater by the base station and the number of different parameters. For example, if the number of different parameters varies for each operating mode, the number of different parameters may be the maximum value among the different numbers of parameters for the operating modes.

The base station may transmit the CSI-RS using the same beam, but its CSI-RS resource identifier (ID) may change depending on a transmission time. The base station may estimate the RIS operating mode and/or control parameter(s) (or control information) based on the CSI-RS ID included in a channel state information feedback (or report) from the terminal (e.g. CSI-RS resource indicator (CRI)).

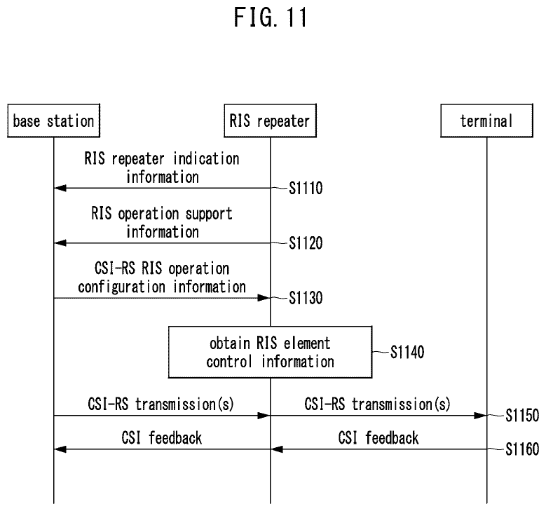

FIG. 11 is a sequence chart illustrating a method for transmitting channel state information via an RIS repeater according to exemplary embodiments of the present disclosure.

Referring to FIG. 11, the base station may determine (or generate) RIS operation configuration information for CSI-RS transmission(s) to the terminal via the RIS repeater based on RIS operation support information received from the RIS repeater. Before the CSI-RS(s) are transmitted from the base station to the terminal via the RIS repeater, the base station may transmit the determined (or generated) RIS operation configuration information to the RIS repeater. The RIS repeater may obtain RIS element control information in advance using the RIS operation configuration information received from the base station and may configure the RIS element(s). The base station may provide (or transmit) CSI-RS transmission(s) to the terminal via the RIS repeater. In FIG. 11, when describing the CSI-RS transmission method via the RIS repeater, similar or redundant description regarding the RIS element control method and procedure and the SSB transmission method via the RIS repeater described above may be omitted.

In step S1110 and step S1120, the base station may receive RIS repeater indication information and RIS operation support information from the terminal. Step S1110 may correspond to step S710, and step S1120 may correspond to step S720.

In step S1130, the base station may determine (or generate) RIS operation configuration information for CSI-RS transmission(s) to the terminal via the RIS repeater (hereinafter referred to as ‘CSI-RS RIS operation configuration information’) based on the RIS operation support information received from the RIS repeater. Before the CSI-RS(s) are transmitted from the base station to the terminal via the RIS repeater, the base station may transmit the determined (or generated) CSI-RS RIS operation configuration information to the RIS repeater. The RIS repeater may receive the CSI-RS RIS operation configuration information from the base station.

In step S1140, the RIS repeater may obtain RIS element control information using the CSI-RS RIS operation configuration information received from the base station in step S1130. The RIS repeater may configure the RIS element(s) based on the obtained RIS element control information.

In step S1130, the base station may inform the RIS repeater in advance of which operating mode the RIS repeater is to operate in at a time of CSI-RS transmission(s) and whether to use values of required parameter(s) when operating in the corresponding RIS operating mode. In step S1140, the RIS repeater may obtain (or generate) the control values for the RIS element(s) in advance based on the information. The RIS repeater may use the corresponding control values at the time when the CSI-RS transmission(s) are transmitted.

In Step S1150, the base station may transmit CSI-RS(s) to the terminal via the RIS repeater. The CSI-RS transmission(s) between the base station and the RIS repeater may be transmitted using CSI-RS beams #1 (e.g. CSI-RS beams #1 1010 in FIG. 10). The CSI-RS transmission(s) between the RIS repeater and the terminal may be transmitted using CSI-RS beams #2 (e.g. CSI-RS beams #2 1020 in FIG. 10).

In step S1160, the terminal may perform a measurement operation on the CSI-RS transmission(s) received in step S1150 to obtain CSI feedback information. The terminal may transmit the obtained feedback information to the base station. The CSI feedback information transmitted by the terminal to the base station may reach the base station via the RIS repeater. The base station may receive the CSI feedback information from the terminal via the RIS repeater.

The base station may determine whether to change the RIS operation configuration information based on the CSI feedback information received from the terminal via the RIS repeater. If the base station determines that the RIS operation configuration information needs to be changed, the base station may transmit the RIS operation configuration information to be changed to the RIS repeater. The RIS repeater may reconfigure the RIS element(s) based on the RIS operation configuration information to be changed. Thereafter, the base station may provide (or transmit) the CSI-RS transmission(s) to the terminal using the reconfigured RIS element(s).

In an exemplary embodiment, it may be assumed that the channel between the RIS repeater and the terminal has changed due to movement of the terminal. The base station may determine that the RIS operation configuration information needs to be changed based on the CSI feedback information received from the terminal via the RIS repeater. If the base station reconfigures the RIS element(s) of the RIS repeater, the base station may suppress CSI-RS transmission(s) at some of the RIS element(s) of the RIS repeater. The base station may add CSI-RS transmission(s) at new RIS element(s) of the RIS repeater.

In another exemplary embodiment, it may be assumed that the channel between the RIS repeater and the terminal has changed due to movement of the terminal. The base station may receive SRS transmission(s) from the terminal via the RIS repeater. The base station may determine whether to change the RIS operation configuration information based on the SRS transmission(s) received from the terminal via the RIS repeater. If the base station determines that the RIS operation configuration information needs to be changed, the base station may transmit the RIS operation configuration information to be changed to the RIS repeater. The RIS repeater may reconfigure the RIS element(s) based on the RIS operation configuration information to be changed. As described above, if the base station reconfigures the RIS element(s) of the RIS repeater, the base station may suppress CSI-RS transmission(s) at some of the RIS element(s) of the RIS repeater. The base station may add CSI-RS transmission(s) at new RIS element(s) of the RIS repeater.

In the above-described CSI-RS transmission method via the RIS repeater, although steps S1110 through S1160 are described separately, this is not intended to limit the order in which the steps are performed. When necessary, the respective steps may be performed simultaneously, in a different order, or combined.

In the present disclosure, the base station may be an entity that controls the RIS repeater through a wireless control link. Conversely, the control entity of the RIS repeater may be changed from the base station to the terminal. In other words, according to the method described in the present disclosure, the terminal may control the RIS repeater and communicate with the base station.

The RIS repeater may have a very large number of RIS elements to control. In the RIS repeater, the arrangement of RIS elements may not be uniform. According to the present disclosure, the overhead for delivering control values to the RIS repeater may be reduced. Regardless of the form of the RIS repeater, the RIS repeater may obtain the RIS element control values.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a communication node, comprising:
transmitting reconfigurable intelligent surface (RIS) operation support information to a base station;
receiving RIS operation configuration information from the base station;
configuring a plurality of RIS elements based on the RIS operation configuration information;
generating second downlink (DL) transmission(s) via the plurality of RIS elements, based on first DL transmission(s) received from the base station; and
transmitting the second DL transmission(s) to a terminal.

2. The method according to claim 1, wherein the transmitting of the RIS operation support information to the base station comprises:
transmitting information indicating whether the communication node is an RIS repeater to the base station; and
transmitting the RIS operation support information to the base station,
wherein the RIS operation support information includes at least one of information on RIS operable mode(s), information on parameter(s) for each of the RIS operable mode(s), or information on a number of bits for each of the parameter(s).

3. The method according to claim 2, wherein the information indicating whether the communication node is an RIS repeater is included in a establishment cause of a radio resource control (RRC) connection setup request transmitted from the communication node to the base station, a resume cause of an RRC connection resume request transmitted from the communication node to the base station, or user equipment (UE) capability information which is a response to a UE capability enquiry of the base station.

4. The method according to claim 1, wherein the first DL transmission is transmitted from the base station to the communication node through fixed beam(s), and the second DL transmission is transmitted from the communication node to the terminal through beam(s) that change over time.

5. The method according to claim 1, wherein a number of the first DL transmission(s) is determined based on at least one of a number of RIS operating modes configured by the base station or a number of different parameters.

6. The method according to claim 1, wherein the first DL transmission(s) correspond to first synchronization signal block (SSB) transmission(s), the second DL transmission(s) correspond to second SSB transmission(s), the first SSB transmission(s) use first SSB transmission resource(s), the second SSB transmission(s) use second SSB transmission resource(s), and the first SSB transmission resource(s) are configured to have at least one of different SSB index(es), SSB transmission time resource(s), or SSB transmission frequency resource(s) from the second SSB transmission resource(s).

7. The method according to claim 1, wherein the first DL transmission(s) correspond to first channel state information-reference signal (CSI-RS) transmission(s), and the second DL transmission(s) correspond to second CSI-RS transmission(s).

8. The method according to claim 1, further comprising: transmitting second uplink (UL) transmission(s) to the base station by changing first UL transmission(s) transmitted from the terminal to the second UL transmission(s) via the plurality of RIS elements.

9. A method of a base station, comprising:
receiving reconfigurable intelligent surface (RIS) operation support information from a communication node;
determining RIS operation configuration information based on the RIS operation support information;
transmitting the RIS operation configuration information to the communication node; and
transmitting first downlink (DL) transmission(s) to a terminal via the communication node,
wherein second DL transmission(s) generated by the communication node via a plurality of RIS elements based on the first DL transmission(s) received from the base station is received by the terminal.

10. The method according to claim 9, wherein the receiving of the RIS operation support information from the communication node comprises:
receiving information indicating whether the communication node is an RIS repeater from the communication node; and
receiving the RIS operation support information from the communication node,
wherein the RIS operation support information includes at least one of information on RIS operable mode(s), information on parameter(s) for each of the RIS operable mode(s), or information on a number of bits for each of the parameter(s).

11. The method according to claim 10, wherein the information indicating whether the communication node is an RIS repeater is included in a establishment cause of a radio resource control (RRC) connection setup request transmitted from the communication node to the base station, a resume cause of an RRC connection resume request transmitted from the communication node to the base station, or user equipment (UE) capability information which is a response to a UE capability enquiry of the base station.

12. The method according to claim 9, wherein the first DL transmission is transmitted from the base station to the communication node through fixed beam(s), and the second DL transmission is transmitted from the communication node to the terminal through beam(s) that change over time.

13. The method according to claim 9, wherein a number of the first DL transmission(s) is determined based on at least one of a number of RIS operating modes configured by the base station or a number of different parameters.

14. The method according to claim 9, wherein the first DL transmission(s) correspond to first synchronization signal block (SSB) transmission(s), the second DL transmission(s) correspond to second SSB transmission(s), the first SSB transmission(s) use first SSB transmission resource(s), the second SSB transmission(s) use second SSB transmission resource(s), and the first SSB transmission resource(s) are configured to have at least one of different SSB index(es), SSB transmission time resource(s), or SSB transmission frequency resource(s) from the second SSB transmission resource(s).

15. The method according to claim 11, wherein the first DL transmission(s) correspond to first channel state information-reference signal (CSI-RS) transmission(s), and the second DL transmission(s) correspond to second CSI-RS transmission(s).

16. The method according to claim 11, further comprising: receiving second uplink (UL) transmission(s), the second UL transmission(s) being changed via the communication node from first UL transmission(s) transmitted by the terminal.

17. A communication node comprising at least one processor, wherein the at least one processor causes the communication node to perform:
transmitting reconfigurable intelligent surface (RIS) operation support information to a base station;
receiving RIS operation configuration information from the base station;
configuring a plurality of RIS elements based on the RIS operation configuration information;
generating second downlink (DL) transmission(s) via the plurality of RIS elements, based on first DL transmission(s) received from the base station; and
transmitting the second DL transmission(s) to a terminal

18. The communication node according to claim 17, wherein the first DL transmission is transmitted from the base station to the communication node through fixed beam(s), and the second DL transmission is transmitted from the communication node to the terminal through beam(s) that change over time.

19. The communication node according to claim 17, wherein a number of the first DL transmission(s) is determined based on at least one of a number of RIS operating modes configured by the base station or a number of different parameters.

20. The communication node according to claim 17, wherein the first DL transmission(s) correspond to first synchronization signal block (SSB) transmission(s), the second DL transmission(s) correspond to second SSB transmission(s), the first SSB transmission(s) use first SSB transmission resource(s), the second SSB transmission(s) use second SSB transmission resource(s), and the first SSB transmission resource(s) are configured to have at least one of different SSB index(es), SSB transmission time resource(s), or SSB transmission frequency resource(s) from the second SSB transmission resource(s).
